(19) United States
(12) Patent Application Publication
(10) Pub. No.: US 2011/0242540 A1
(43) Pub. Date: Oct. 6, 2011

(54) RAIN SENSOR

(75) Inventors: San-Woei SHYU, Taipei (TW); Ming-Che KUO, Taipei (TW); Bo-Yuan SHIH, Taipei (TW)

(73) Assignee: E-PIN OPTICAL INDUSTRY CO., LTD., Taipei (TW)

(21) Appl. No.: 13/029,819

(22) Filed: Feb. 17, 2011

(30) Foreign Application Priority Data
Apr. 2, 2010 (TW) 099205971

(51) Int. Cl. G01N 21/55

(52) U.S. Cl. 356/445

(57) ABSTRACT

A rain sensor mounted on a windshield of a vehicle comprises: a housing having an opening, at least an emitter disposed in the housing and used for emitting light beams, a coupler, and an optical detector. The coupler connecting and covering the opening of the housing, comprises: at least a collimator receiving and collimating the light beams into collimated light beams; and at least a groove having a deflection surface to reflect the collimated light beams that passes through the collimator and is incident to the deflection surface at an incident angle θ to the windshield. The optical detector disposed in the housing is used for receiving the collimated light beams reflected by the windshield and generating electrical signals. The present invention characterized in that the incident angle θ satisfies the following condition: 1.27<n*sin θ<1.52, wherein n is refractive index of the coupler.

### FIELD OF THE INVENTION

The present invention relates to a rain sensor, and more particularly, to a rain sensor which detects rain or moisture on a windshield of a vehicle by optical reflecting.

### BACKGROUND OF THE INVENTION

A wiper, a necessary equipment for a vehicle now, is used for removing rain or moisture accumulated on a windshield of a vehicle to enhance driver's vision through the windshield.

The wiper now is generally operated by the driver through manually opening the wiper's switch, and it can intermittently swing to remove the rain. A wiper control system have recently been developed in recent years, which installs on the inner surface of the windshield, such as U.S. Pat. No. 5,898,183 and U.S. Pat. No. 5,661,303. They disclose a configuration of the wiper control system.

Referring to FIG. 1, the wiper control system includes a rain sensor 10 attached to the inner surface of the windshield 14. If rain is accumulated on the outer surface of the windshield 14, the rain sensor 10 can detect whether rain exists on the windshield 14 or not by optical reflecting. If rain sensor 10 detects that rain exists on the outer surface of the windshield 14, it will actuate the motor (not shown in the drawing) automatically to drive the wiper 12 to swing.

Referring to FIG. 2, the rain sensor 10 includes a housing 110 and a coupler 120 coupling to the upper housing 110. The rain sensor 10 further includes a LED 130 and an optical detector 140 disposed in the housing 110. The coupler 120 has a collimator 122 corresponding to the LED 130 and a focuser 124 corresponding to the optical detector 140. In operation, the LED 130 emits light beams. The light beams are collimated by the collimator 122, enter the windshield 14 and are totally reflected from the outer surface of the windshield 14 to the focuser 124. The light beams then are focused by the focuser 124 to the optical detector 140, and then are received by the optical detector 140.

Although the rain sensor 10 descried above can detect rain on the outer surface of the windshield automatically to actuate the wiper, the collimator 122 doesn't face the LED 130 directly so that the whole light beams emitted from the LED 130 can't be received by the collimator 122; therefore, some light beams are loss. Generally speaking, the more light beams emitted from LED 130 enter into the collimator 122, the more light beams are received by the optical detector 140; therefore, light efficiency of the rain sensor 10 is high and sensitivity of detection is good. Hence, the sensitivity of detection in the conventional rain sensor 10 described above can't be high.

In order to solve the problems described above, referring to FIGS. 3 and 4, EP 1026496 and U.S. Pat. No. 7,573,576 disclose that the collimator 122 is disposed to directly correspond to the LED 130 so that the light beams emitted from the LED 130 are almost completely received by the collimator 122.

Although the light beams emitted from the LED 130 can be completely received by the collimator 122 of the rain sensor 10, an angle of the light beams incident to the deflection surface, called the incident angle θ below, is about 40°. If the incident angle θ is small, some light beams will be refracted and some light beams will be reflected, hence a part of light beams are loss and the light beams finally received by the optical detector 140 are less so that the light efficiency is low and the sensitivity of the detection is bad. Nowadays the light efficiency of the conventional rain sensor 10 is only about 10%. General speaking, the incident angle θ must greater than 50°, the light efficiency will be high. Furthermore, when the light beams are reflected once, a part of light beams will lose. The light beams are reflected many times in the rain sensor 10 of FIG. 4 so that the light efficiency can't be increased.

Therefore, how to enhance the light efficiency to increase the sensitivity of detection of rain sensor is a problem that the present invention wants to solve.

### SUMMARY OF THE INVENTION

An object of the present invention is to provide a rain sensor which can solve the problem that the light efficiency is low in the prior art.

Another object of the present invention is to provide a rain sensor which can effectively expand the total range of the detecting area on the windshield.

The present invention provides a rain sensor mounted on a windshield of a vehicle. The rain sensor comprises a housing, at least an emitter, a coupler, and an optical detector. The housing has an opening. The emitter is disposed in the housing and is used for emitting light beams. The coupler connecting and covering the opening of the housing, comprises: at least a collimator corresponding to the emitter to completely receive the light beams emitted from the emitter and to collimate the light beams into collimated light beams; and at least a groove having a deflection surface corresponding to the collimator, and being used to reflect the collimated light beams that passes through the collimator and is incident to the deflection surface at an incident angle θ to the windshield. The optical detector is disposed in the housing and is used for receiving the collimated light beams reflected by the windshield and generating electrical signals in response to the collimated light beams. The present invention characterized in that the collimated light beams incident to the coupler satisfies the following condition:

1.27<n*sin θ<1.52

wherein n is refractive index of the coupler, and θ is the incident angle of the collimated light beams incident to the deflection surface.

By using the technique of the present invention, the present invention can increase the light efficiency of the rain sensor up to 22%. The light efficiency increases about 54% by comparing with the conventional rain sensor, and the detection sensitivity of the rain sensor is effectively improved. Besides, the present invention effectively expands the total range of the detecting area on the windshield by comparing with the conventional rain sensor. For example, the rain sensor in the present invention is six times the total range of the detecting area before so that rain sensor can detect the moisture easier and corresponds to the actual situation of rainy day better.

### BRIEF DESCRIPTION OF THE DRAWINGS

FIG. 1 is a schematic diagram showing a conventional rain sensor attached to a windshield of a vehicle.

FIGS. 2 through 4 are diagrams showing the structure of the conventional rain sensor.

FIG. 5 is a solid diagram showing a structure of a rain sensor according to one embodiment of the present invention.

FIG. 6 is an exploded diagram of FIG. 5, wherein the covering surface of the coupler is facing downward.

FIG. 7 is a solid diagram showing the covering surface of the coupler of the rain sensor according to the present invention.

FIG. 8 is a top view showing the rain sensor being used.

FIG. 9 is a section diagram of FIG. 8 showing the coupler of the rain sensor adhered to the windshield.

FIG. 10 is a diagram showing paths of the light beams when rain sensor is used according to the present invention.

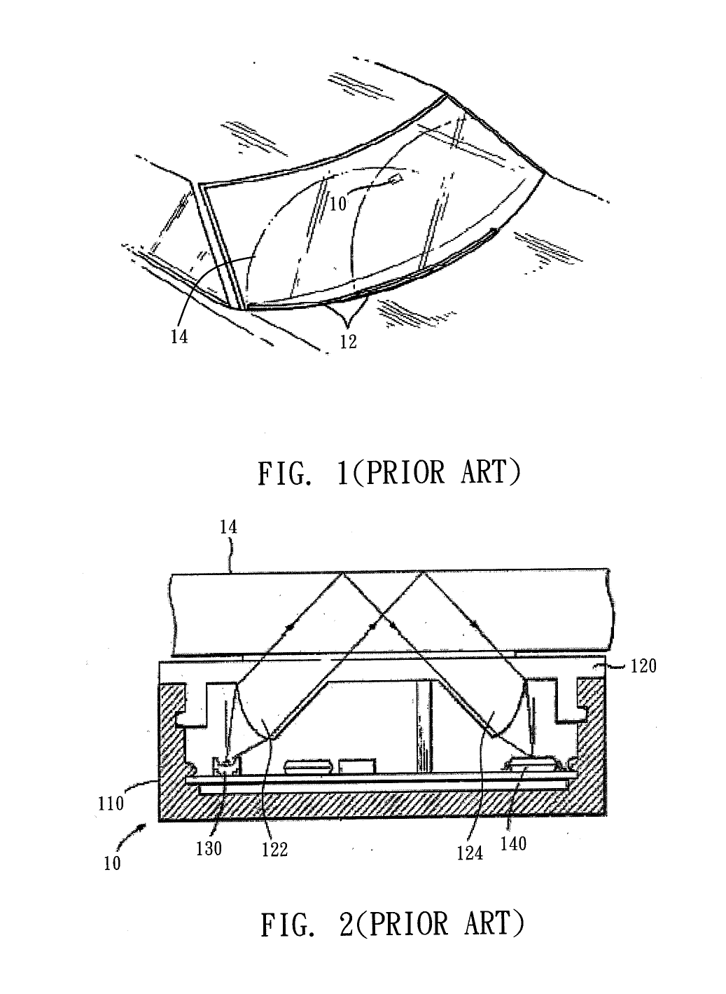

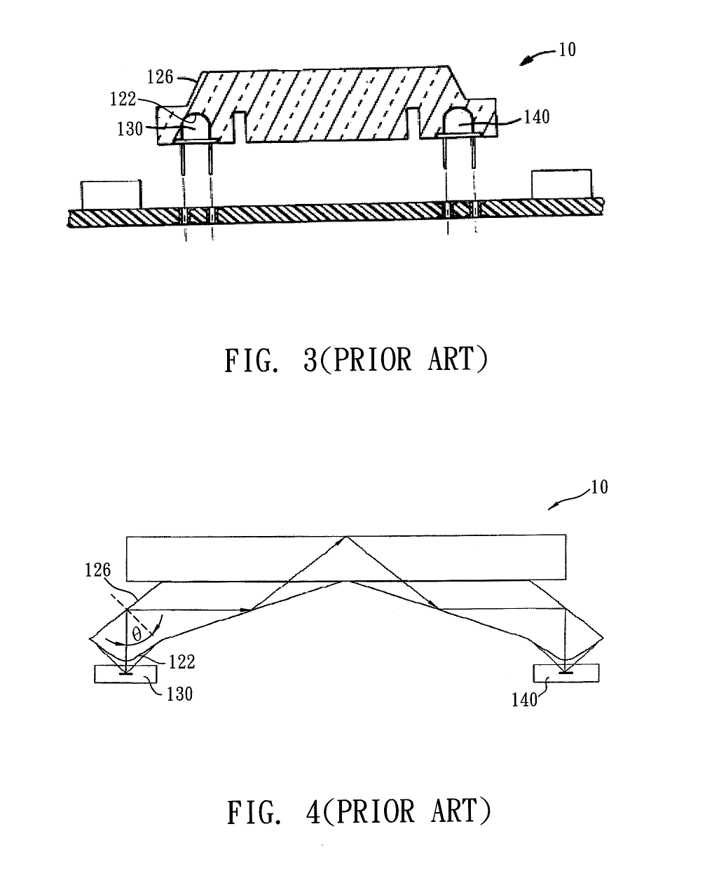

### DETAILED DESCRIPTION OF THE PREFERRED EMBODIMENTS

In order to make the present invention more explicit and detailed, the structures and the technique features of the present invention will be described below by taking best examples with the corresponding drawings below.

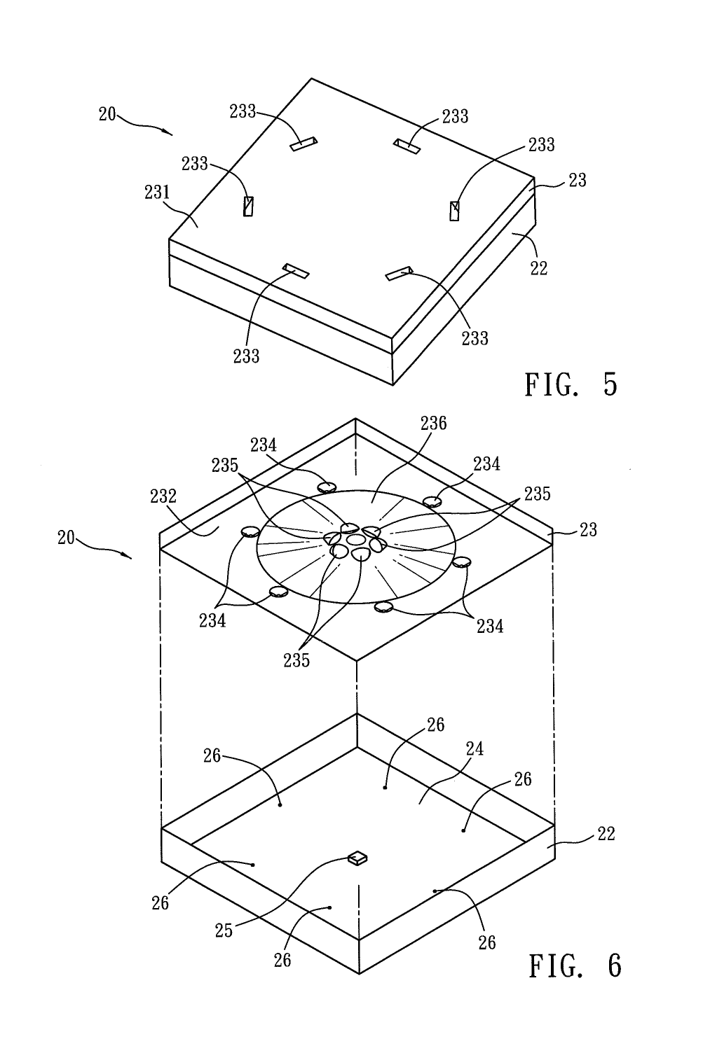

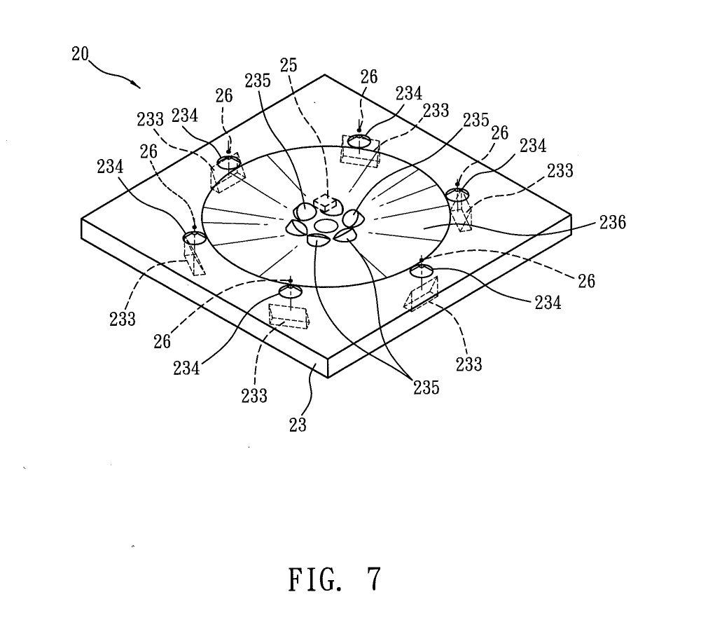

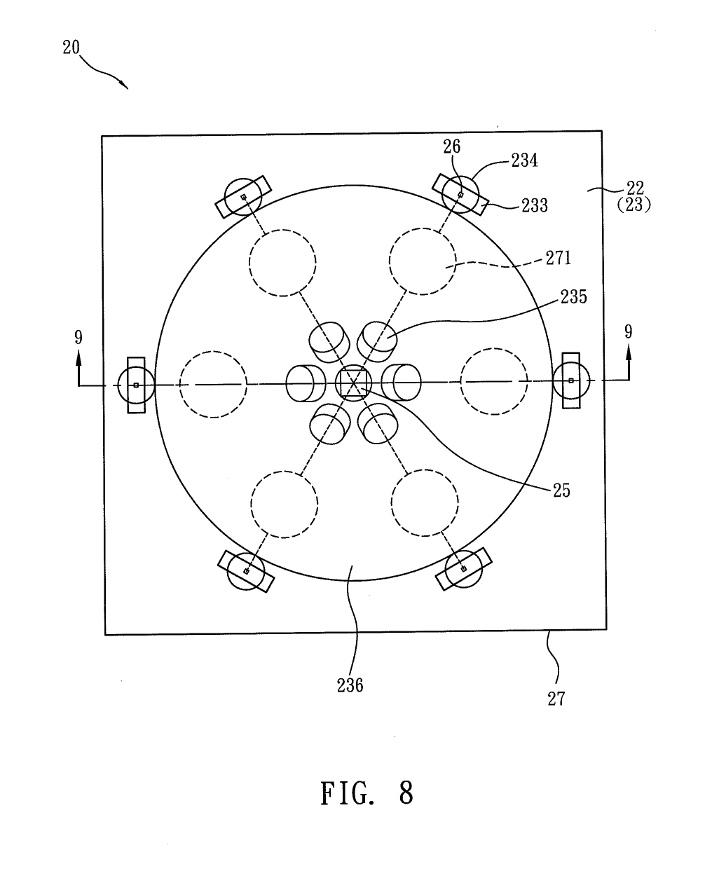

FIG. 5 is a solid diagram showing a structure of a rain sensor 20 according to one embodiment of the present invention. FIG. 6 is an exploded diagram of FIG. 5, wherein the covering surface 232 of the coupler 23 is facing downward. FIG. 7 is a solid diagram showing the covering surface 232 of the coupler 23 of the rain sensor 20. FIG. 8 is a top view showing the rain sensor 20 being used.

Referring to FIGS. 5 through 8, the rain sensor 20 of the present embodiment includes a housing 22 and a coupler 23. The housing 22 is made from opaque and plastic material, and is rectangle. The housing 22 has an opening 24. The coupler 23 is a transparent element that the light beams can pass, and the coupler 23 connects to the housing 22 and covers with the opening 24. A circuit board (not shown in the diagram) is disposed inside the housing 22, and an optical detector 25 and at least an emitter 26 surrounding the optical detector 25 are disposed on the circuit board. The optical detector 25 can receive the light beams emitted from the emitter 26 and generates electrical signals in response to the received light beams. The emitter 26 is a light source that can emits light beams, and a light-emitting diode (LED) emitted along its central axis is generally used.

In this embodiment, there includes one optical detector 25 and six emitters 26, and six emitter 26 are arranged in a loop at equal distance circumferentially around the optical detector 25 and at equal distance from the optical detector 25. However, the present invention is not limited to this embodiment, the number of the emitter 26 can also be one, two, three, or over, and the distance between the optical detector 25 and each the emitter 26 can be different.

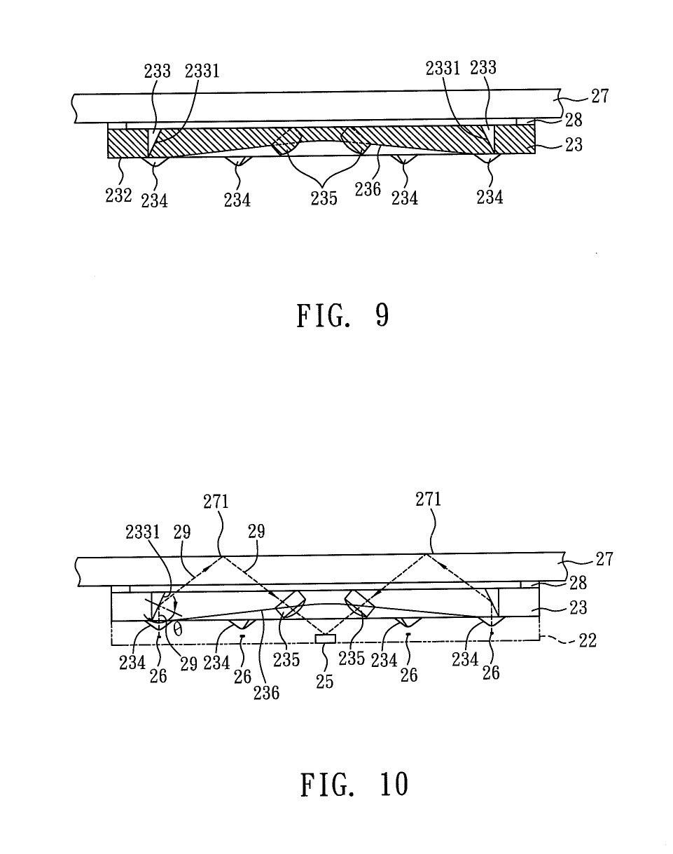

The coupler 23 includes an adhering surface 231 and a covering surface 232. The adhering surface 231 can be adhered to a windshield 27 of a vehicle by using double-side adhesive tape 28, and the covering surface 232 is facing the housing 22, shown in FIGS. 9 and 10. The coupler 23 further includes multiple grooves 233, multiple collimators 234, and multiple focusers 235.

FIG. 9 is a section diagram showing the coupler 23 of the rain sensor 20 adhered to the windshield 27. For clear description, FIG. 9 is only a sectional view of line 9-9 in FIG. 8. In order to best describe the structures and the connections of the grooves 233, the collimators 234, and the focusers 235, please referring to FIGS. 5 through 9 at the same time.

The multiple collimators 234 are disposed on the covering surface 232 of the coupler 23 and correspond to each the emitter 26 respectively, that is correspond to the central axis of each the LED. In this embodiment, The collimators 234 are plano-convex lenses, and the convex surfaces of the collimators 234 protrudes from the covering surface 232 and face the emitters 26. The collimators 234 can completely receive the light beams emitted from the emitters 26 and collimate the light beams into collimated light beams. In present embodiment, the multiple collimators 234 and the coupler 23 are integrally formed.

The multiple grooves 233 are falling down from the adhering surface 231 of the coupler 23, and the air can enter the grooves 233. Each the groove 233 is a pyramid shape and has a deflection surface 2331 corresponding to the collimator 234. The deflection surface 2331 is an interface between the air and the coupler 23.

The multiple focusers 235 are disposed on the covering surface 232 of the coupler. In present embodiment, the multiple focusers 235 and the coupler 23 are integrally formed. Because the structure of each the focuser 235 is the same as the conventional focuser, the present invention doesn't give unnecessary details again. When rain sensor is used, the focuser 235 can focus the light beams totally reflected by the windshield to the optical detector 25, and the light beams are received by the optical detector 25. The number of the groove 233, collimator 234, and the focuser 235 corresponds with the number of the emitter 26. In present embodiment, there are six emitters 26 so that the respective number of the groove 233, collimator 234, and the focuser 235 is six.

Referring to FIG. 10, which is a diagram showing paths of the light beams when rain sensor 20 is used according to the present invention. In order to clearly describe the paths of the light beams, one light beam emitted from the emitter 26 is shown.

When the emitter 26 emits light beam 29, the collimator 234 completely receives the light beam 29 and collimates the light beam 29 into a collimated light beam 29. The collimated light beam 29 then is incident to the deflection surface 2331 at a specific angle θ, which is an angle between the collimated light beam 29 and a normal of the deflection surface 2331, called the incident angle θ. If the whole coupler 23 is made from one material, that is, the refraction index n of the coupler 23 is the same. Because the incident angle θ of the collimated light beam 29 incident to the deflection surface 2331 is larger enough, the deflection surface 2331 can totally reflect the collimated light beam 29 to the windshield 27; therefore, the loss of the light beams is reduced. If rain or moisture exists on the outer surface of the windshield 27, the light beams 29 incident to the windshield 27 will be totally reflected by the windshield 27. A detecting area 271 that reflects light beams on the windshield 27 can detect whether the moisture exists on the windshield 27 or not. When there is no rain on the detecting area 271, air will be outside the windshield 27. The outer surface of the windshield 27 will be an interface between windshield 27 and the air, and the light beams 29 will not be totally reflected. When there is rain on the detecting area 271, moisture is formed on the outer surface of the windshield 27. The outer surface of the windshield 27 will be an interface between windshield 27 and the moisture, and the light beams 29 will be totally reflected to the focuser 235 and be focused by the focuser 235 on the optical detector 25.

The coupler used in the present embodiment is made of a material and it is refractive index n is between 1.50 and 1.60. The incident angle θ of the light beam 29 incident to the deflection surface 2331 is between 60° and 70°. The range of n*sin θ can be obtained by calculating, please referring to Table one.

TABLE ONE

| refractive index n | incident angle θ | n * sinθ |
|---|---|---|
| 1.50 | 60 | 1.2990 |
| | 63 | 1.3365 |
| | 66 | 1.3703 |
| | 70 | 1.4095 |
| 1.52 | 60 | 1.3164 |
| | 63 | 1.3543 |
| | 66 | 1.3886 |
| | 70 | 1.4283 |
| 1.54 | 60 | 1.3337 |
| | 63 | 1.3721 |
| | 66 | 1.4069 |
| | 70 | 1.4471 |
| 1.56 | 60 | 1.3510 |
| | 63 | 1.3900 |
| | 66 | 1.4251 |
| | 70 | 1.4659 |
| 1.58 | 60 | 1.3683 |
| | 63 | 1.4078 |
| | 66 | 1.4434 |
| | 70 | 1.4847 |
| 1.60 | 60 | 1.3856 |
| | 63 | 1.4256 |
| | 66 | 1.4617 |
| | 70 | 1.5035 |

By designing the refractive index n of the coupler 23 described above and the incident angle θ of the light beam 29 incident to the deflection surface 2331, the n*sin θ can satisfy the following condition:

1.27<n*sin θ<1.52

If n*sin θ satisfy the condition describe above in the present invention, the light efficiency of the optical detector 25 will be better, especially if n is 1.585, θ is 65°, and n*sin θ is 1.4365, the light efficiency can be up to 22%. The light efficiency increases about 54% by comparing with the conventional rain sensor, and the detection sensitivity of the rain sensor 20 is effectively improved.

Referring to FIGS. 8 and 10 again, the present embodiment disposes six emitters 26 arranged in a loop at equal distance from the optical detector in the housing 22, and disposes six grooves 233, six collimators 234, and six focusers 235 whose number is the same as the emitter on the coupler 23 so that six detecting areas 271 are formed on the windshield 27. Comparing with the structure of conventional rain sensor, the present invention effectively expands the range of the detecting area so that rain sensor 20 can detect the moisture easier and corresponds to the actual situation of rainy day better.

Besides, the emitters 26 in the present invention can be arranged at unequal distance from the optical detector 25 to expand the range of the detecting area 271.

In addition, referring to FIG. 6, a concave part 236 can be disposed in the central area of the covering surface 232 of the coupler 23 so that the multiple focuser 235 doesn't protrude from the covering surface 232 of the coupler 23 as shown in FIGS. 9 and 10. Hence, the actual thickness of the coupler 23 won't be increased, and it benefits the design of the light path of the multiple focusers 235.

The descriptions above are only best embodiments of the present invention. It is only to illustrate not to limit the present invention. Those skilled in the art would recognize that the embodiments can be changed, modified, or further equivalently displaced within the spirits and the ranges limited by the claims in the present invention.

What is claimed is:

1. A rain sensor mounted on a windshield of a vehicle, comprising:
a housing having an opening;
at least an emitter disposed in the housing and being used to emit light beams;
a coupler connecting with the housing and covering the opening of the housing, comprising:
at least a collimator corresponding to the emitter to completely receive the light beams emitted from the emitter and to collimate the light beams into collimated light beams; and
at least a groove having a deflection surface corresponding to the collimator, and being used to reflect the collimated light beams that passes through the collimator and is incident to the deflection surface at an incident angle θ to the windshield, and
an optical detector disposed in the housing and being used to receive the collimated light beams reflected by the windshield and to generate electrical signals in response to the collimated light beams;
characterized in that the collimated light beams incident to the coupler satisfies the following condition:
1.27<n*sin θ<1.52
wherein n is refractive index of the coupler, and θ is the incident angle of the collimated light beams incident to the deflection surface.

2. The rain sensor as claimed in claim 1, wherein the coupler is made of a transparent material of the refractive index n between 1.50 and 1.60.

3. The rain sensor as claimed in claim 1, wherein the incident angle θ is between 60° and 70°.

4. The rain sensor as claimed in claim 1, wherein the coupler made of a transparent material of the refractive index n is 1.585, and the incident angle of θ is 65°.

5. The rain sensor as claimed in claim 1, wherein at least three emitters are arranged in a loop at equal distance from the optical detector.

6. The rain sensor as claimed in claim 1, wherein at least two emitters are arranged at unequal distance from the optical detector.

7. The rain sensor as claimed in claim 1, wherein the coupler further comprises at least a focuser for focusing the collimated light beams reflected by the windshield to the optical detector.

8. The rain sensor as claimed in claim 7, wherein the coupler has a surface facing the optical detector, a concave part is formed in the central area of the surface, and the focuser is disposed on the concave part so that the focuser doesn't protrude from the surface of the coupler.

9. The rain sensor as claimed in claim 1, wherein the emitter is a LED emitting light along its central axis, and the collimator corresponds to the central axis of the LED.

10. The rain sensor as claimed in claim 1, wherein the groove is falling down from a surface of the coupler toward the windshield, and the air can enter the groove so that the deflection surface is an interface between the air and the coupler and can totally reflect the collimated light beams to the windshield.
